(19) United States
(12) Patent Application Publication
(10) Pub. No.: US 2025/0162069 A1
(43) Pub. Date: May 22, 2025

(54) LASER PROCESSING APPARATUS

(71) Applicant: SAMSUNG SDI CO., LTD., Yongin-si (KR)

(72) Inventor: Kyuchul CHOI, Yongin-si (KR)

(21) Appl. No.: 18/770,240

(22) Filed: Jul. 11, 2024

(30) Foreign Application Priority Data
Nov. 17, 2023 (KR) 10-2023-0159789

(51) Int. Cl. B23K 26/066; B23K 26/06; B23K 26/082; B23K 26/144; B23K 35/38

(52) U.S. Cl. CPC B23K 26/066; B23K 26/0648; B23K 26/082; B23K 26/144; B23K 35/38

(57) ABSTRACT

A laser processing apparatus includes a laser emitter configured to provide a laser along a scan path to a workpiece, a lens arranged below the laser emitter, and a first layer configured to supply a first blocking layer and a second blocking layer between the lens and the workpiece along the height direction, wherein the first layer includes a first sub-layer and a second sub-layer spaced apart from each other, the first sub-layer is configured to provide the first blocking layer, the second sub-layer is configured to provide the second blocking layer, the scan path is parallel to a first direction perpendicular to the height direction, and the first layer and the second layer are spaced apart along a second direction perpendicular to the height direction and intersect the first direction, with the scan path interposed therebetween.

### CROSS-REFERENCE TO RELATED APPLICATION

The present application claims priority to and the benefit of Korean Patent Application No. 10-2023-0159789 filed at the Korean Intellectual Property Office on Nov. 17, 2023, the entire disclosure of which is incorporated herein by reference.

### BACKGROUND

### 1. Field

The present disclosure relates to a laser processing apparatus.

### 2. Description of the Related Art

A laser processing apparatus may use a laser to focus energy on a local

area of a workpiece to perform processes such as cutting or joining through heat.

When a laser is focused on the workpiece using a laser processing apparatus, the workpiece melts with high heat. As the molten workpiece boils at a high temperature, spatter may be generated from the molten workpiece and bounce in irregular directions. The process environment may be contaminated by such spatter, and a scanner lens for laser irradiation may be contaminated.

If the scanner lens is contaminated by spatter, errors may occur in the laser irradiation process due to interference during laser irradiation, requiring cleaning or replacement of the lens to eliminate process errors.

### SUMMARY

Embodiments of the present disclosure are directed to a laser processing apparatus capable of reducing or preventing process errors from occurring by reducing or preventing contamination of a scanner lens for laser irradiation.

However, embodiments of the present disclosure are not limited to those mentioned above, and may be extended or modified in various different ways, all without departing from the spirit or scope of the technical ideas, aspects, and features included in the embodiments.

A laser processing apparatus according to one or more embodiments of the present disclosure include a laser emitter configured to provide a laser along a scan path to a workpiece, a lens arranged below the laser emitter, and a first layer configured to supply a first blocking layer and a second blocking layer between the lens and the workpiece along the height direction, wherein the first layer includes a first sub-layer and a second sub-layer spaced apart from each other, the first sub-layer is configured to supply the first blocking layer, the second sub-layer is configured to supply the second blocking layer, the scan path is parallel to a first direction perpendicular to the height direction, and the first layer and the second blocking layer are spaced apart along a second direction perpendicular to the height direction and intersect the first direction, with the scan path interposed therebetween.

The first blocking layer may include a plurality of first blocking particles, and the second blocking layer may include a plurality of second blocking particles.

The first blocking layer and the second blocking layer may be air curtains.

The plurality of first blocking particles and the plurality of second blocking particles may be carbon dioxide particles.

Along the height direction, the first sub-layer and the second sub-layer may be closer to the lens than the workpiece.

The laser processing apparatus may further include a second layer configured to supply a third blocking layer and a fourth blocking layer between the lens and the workpiece along the height direction.

The second layer may include a third sub-layer and a fourth sub-layer spaced apart from each other, the third sub-layer may supply the third blocking layer, and the fourth sub-layer may supply the fourth blocking layer.

The third blocking layer and the fourth blocking layer may be spaced apart along the second direction with the scan path interposed therebetween.

The third blocking layer may include a plurality of third blocking particles, and the fourth blocking layer may include a plurality of fourth blocking particles.

The third blocking layer and the fourth blocking layer may include an air curtain.

The plurality of third blocking particles and the plurality of fourth blocking particles may include carbon dioxide particles.

Along the height direction, the third blocking layer may overlap the first blocking layer, and the fourth blocking layer may overlap the second blocking layer.

Along the height direction, the first layer may be closer to the lens than the workpiece, and the second layer may be closer to the workpiece than the lens.

The laser processing apparatus may further include a film generator configured to supply a blocking film between the lens and the workpiece along the height direction.

The blocking film may be a gas film containing an inert gas.

The inert gas may include nitrogen.

Along the height direction, the film generator may be closer to the lens than the workpiece, and the first layer may be closer to the workpiece than the lens.

The film generator may be disposed based on a region occupied by the lens along a plane direction formed by the first direction and the second direction.

According to embodiments, a laser processing apparatus capable of reducing or preventing process errors from occurring by reducing or preventing contamination of a scanner lens for laser irradiation may be provided.

However, embodiments of the present disclosure are not limited to those mentioned above, and may be variously extended without departing from the spirit and scope of the present disclosure.

### BRIEF DESCRIPTION OF THE DRAWINGS

FIG. 1 is a side view of a laser processing apparatus according to an embodiment.

FIG. 2 is a plan view of a portion of the laser processing apparatus of FIG. 1.

FIG. 3 is a side view of a laser processing apparatus according to one embodiment.

FIG. 4 is a plan view of a portion of the laser processing apparatus of FIG. 3.

FIG. 5 is a plan view of a portion of the laser processing apparatus of FIG. 3.

FIG. 6 is a side view of a laser processing apparatus according to one embodiment.

FIG. 7 is a plan view of a portion of the laser processing apparatus of FIG. 6.

FIG. 8 is a plan view of a portion of the laser processing apparatus of FIG. 6.

### DETAILED DESCRIPTION

Hereinafter, the present disclosure will be described in detail with reference to the accompanying drawings, in which embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

The accompanying drawings are intended only to facilitate an understanding of the exemplary embodiments disclosed in this specification, and it is to be understood that the technical ideas, features, and aspects disclosed herein are not limited by the accompanying drawings and include all modifications, equivalents, or substitutions that are within the range of the ideas and technology of the present disclosure as will be appreciated by a person of skill in the art.

A person of ordinary skill in the art would appreciate, in view of the present disclosure in its entirety, that a feature of embodiments of the present disclosure may be combined or combined with one or more other features, partially or entirely, and may be technically interlocked and operated in various suitable ways, and an embodiment may be implemented independently of one or more other embodiments, or in conjunction with the one or more other embodiments in a suitable manner, unless expressly stated or implied otherwise.

The size and thickness of the various elements, layers, etc. in the drawings are arbitrarily illustrated for better understanding and the sake of description, and the following embodiments are not limited thereto. The same reference numerals designate the same elements.

In the drawings, the thickness of layers, films, panels, regions, etc., are exaggerated for clarity of illustration. In the drawings, the thickness of some layers and regions may be exaggerated for the sake of description.

It will be understood that when an element such as a layer, film, region, or substrate is referred to as being “on,” “connected to,” or “coupled to” another element, it can be directly on, connected, or coupled to the other element or intervening elements may also be present. Thus, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function. When an element is referred to as being “directly on,” “directly connected to,” or “directly coupled to” another element, there are no intervening elements present. For example, when a first element is described as being “coupled” or “connected” to a second element, the first element may be directly coupled or connected to the second element or the first element may be indirectly coupled or connected to the second element via one or more intervening elements.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

Further, when an element is referred to as being “on” or “above” a reference element, it can be positioned above or below the reference element, and it is not necessarily referred to as being positioned “on” or “above” it in the direction opposite to gravity.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. In addition, unless explicitly described to the contrary, the word “comprise,” and variations such as “including,” “comprises” or “comprising,” will be understood to imply the presence or inclusion of stated features, integers, steps, operations, components, and/or elements but not the exclusion, preclusion, or addition of any other features, integers, steps, operations, components, and/or elements. I

[symbol]

In addition, the phrase “in plan view” means a view from a position above the object (e.g., from the top), and the phrase “in cross-section” means a view of a cross-section of the object which is vertically cut from the side.

Hereinafter, various embodiments and variations of the present disclosure will be described in detail with reference to the drawings.

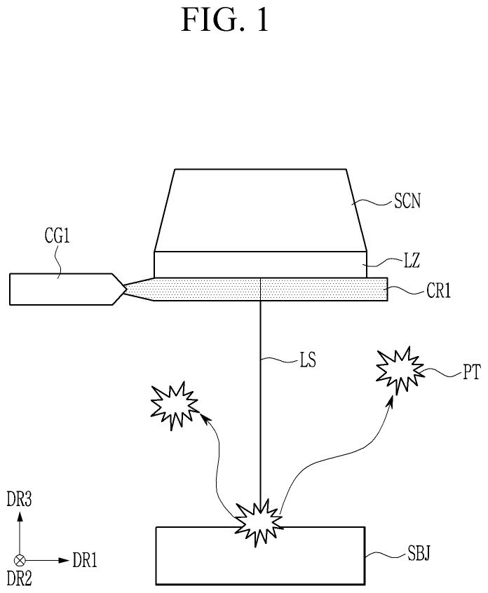

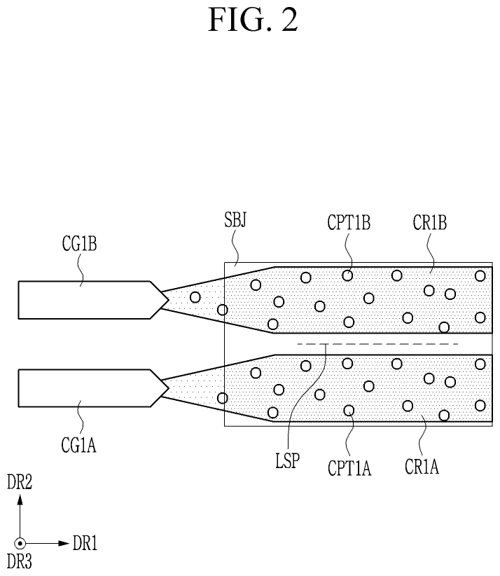

FIGS. 1 and 2 depict a laser processing apparatus according to an embodiment of the present disclosure. FIG. 1 is a side view of a laser processing apparatus according to an embodiment, and FIG. 2 is a plan view of a portion of the laser processing apparatus of FIG. 1.

Referring to FIGS. 1 and 2, a laser processing apparatus 111 according to one embodiment may include a laser supply part (also referred to as a laser emitter) SCN that supplies a laser LS to a processing target workpiece SBJ, a lens part (also referred to as a lens) LZ for focusing the laser supplied from the laser supply part SCN to the processing target workpiece SBJ, and a blocking layer supply part (also referred to as a first layer) CG1 for supplying a blocking layer CR1.

The laser supply part SCN may supply the laser LS while scanning the surface of the workpiece SBJ along a scan path LSP.

The scan path LSP may be parallel to a first direction DR1 among the plane directions in which the workpiece SBJ is disposed.

The lens part LZ may focus the supplied laser LS on the workpiece SBJ.

Referring to FIG. 2, the blocking layer supply part CG1 may include a first sub-blocking layer supply part (also referred to as a first sub-layer) CG1A and a second sub-blocking layer supply part (also referred to as a second sub-layer) CG1B spaced apart along a second direction DR2 crossing the first direction DR1.

The blocking layer supply part CG1 may be disposed between the lens part LZ and the workpiece SBJ along a third direction DR3, (e.g., a height direction). According to the embodiment of FIGS. 1 and 2, the blocking layer supply part CG1 may be disposed closer to the lens part LZ than the workpiece SBJ along the third direction DR3.

The first sub-blocking layer supply part CG1A of the blocking layer supply part CG1 may supply a first blocking layer CR1A, and the first blocking layer CR1A may include a plurality of first blocking particles CPT1A.

The second sub-blocking layer supply part CG1B of the blocking layer supply part CG1 may supply a second blocking layer (also referred to as a second layer) CR1B, and the second blocking layer CR1B may include a plurality of second blocking particles CPT1B.

The first blocking layer CR1A and the second blocking layer CR1B may be spaced apart along the second direction DR2 with the scan path LSP interposed therebetween.

The first sub-blocking layer supply part CG1A and the second sub-blocking layer supply part CG1B may be or include air knives or air nozzles, but the embodiment is not limited thereto.

The first blocking layer CR1A and the second blocking layer CR1B may be or include air curtains, and a plurality of first blocking particles CPT1A and a plurality of second blocking particles CPT1B may be or include carbon dioxide particles.

When supplying the laser LS onto the workpiece SBJ, the spatter PT may be generated from the workpiece SBJ at a certain temperature and may bounce in irregular directions. The process environment and the lens part LZ may be contaminated by the spatter PT, and the laser LS energy may be reduced, resulting in quality defects.

The laser processing apparatus 111 according to one or more embodiments may include the blocking layer supply part CG1 disposed between the lens part LZ and the workpiece SBJ along the third direction DR3 (e.g., the height direction, and provide the first blocking layer CR1A and the second blocking layer CR1B, each including a plurality of first blocking particles CPT1A and a plurality of second blocking particles CPT1B.

The first blocking layer CR1A and the second blocking layer CR1B supplied from the blocking layer supply part CG1 may reduce or prevent (e.g., as a primary measure) the spatter PT from reaching the lens part LZ by an air curtain, and the plurality of first blocking particles CPT1A and a plurality of second blocking particles CPT1B may hit (e.g., directly hit) the spatter PT particles to reduce or prevent (e.g. as a secondary measure) the spatter PT from reaching the lens part LZ.

In addition, the blocking layer supply part CG1 may include the first blocking layer CR1A and the second blocking layer CR1B spaced apart along the second direction DR2 with the scan path LSP parallel to the first direction DR1 interposed therebetween. In one embodiment, the first blocking layer CR1A and the second blocking layer CR1B may be spaced apart along the second direction DR2 with the scan path LSP interposed therebetween.

In one embodiment, the first blocking layer CR1A and the second blocking layer CR1B are spaced apart along the second direction DR2 with the scan path LSP interposed therebetween According to this embodiment, the first blocking layer CR1A, the second blocking layer CR1B, and a plurality of first blocking particles CPT1A and a plurality of second blocking particles CPT1B may not be disposed on the scan path LSP to which the laser LS is supplied. In one embodiment, contamination of the process environment and the lens part LZ by the spatter PT may be prevented or reduced without interfering with the path of the laser LS or reducing the energy intensity of the laser LS.

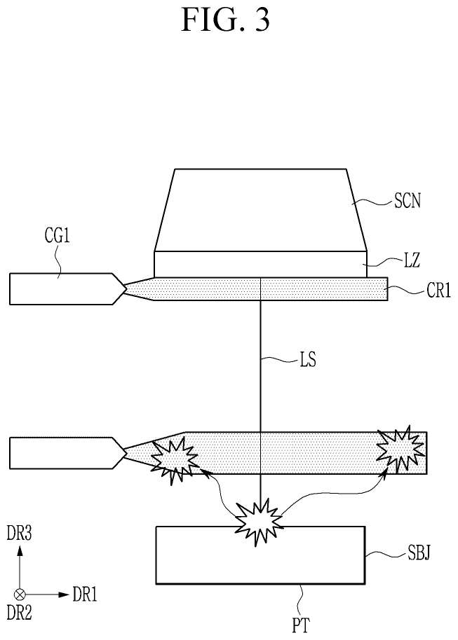

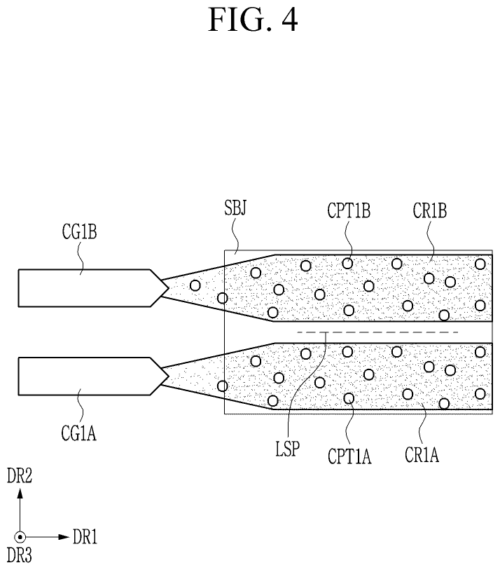

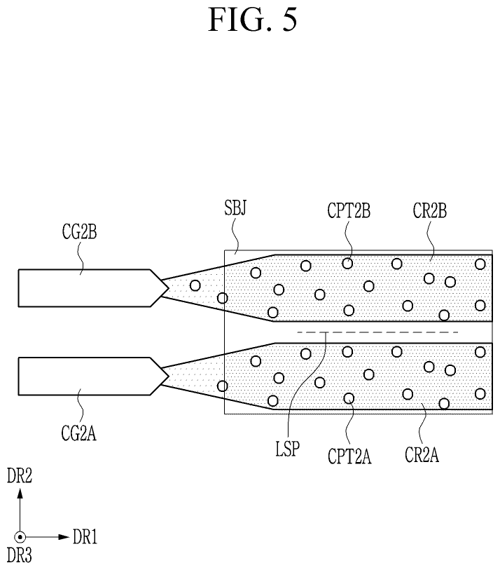

FIGS. 3 to 5 depict a laser processing apparatus 112 according to one embodiment of the present disclosure. FIG. 3 is a side view of a laser processing apparatus according to one embodiment, FIG. 4 is a plan view of a portion of the laser processing apparatus of FIG. 3, and FIG. 5 is a plan view of a portion of the laser processing apparatus of FIG. 3.

A laser processing apparatus 112 according to the embodiment of FIGS. 3 to 5 is similar to the laser processing apparatus 111 according to the embodiment previously described with reference to FIGS. 1 and 2. Detailed descriptions of the same components are omitted.

Referring to FIG. 3, the laser processing apparatus 112 according to the one embodiment may include the laser supply part SCN that supplies the laser LS to the processing target workpiece SBJ, the lens part LZ for focusing the laser supplied from the laser supply part SCN to the processing target workpiece SBJ, and the blocking layer supply parts CG1 and CG2 for supplying the blocking layers CR1 and CR2.

In the laser processing apparatus 112 according to the embodiment of FIG. 3, the blocking layer supply parts CG1 and CG2 may include the first blocking layer supply part CG1 and the second blocking layer supply part CG2 spaced apart from each other along the third direction DR3 (e.g., a height direction).

The first blocking layer supply part CG1 and the second blocking layer supply part CG2 may be disposed between the lens part LZ and the workpiece SBJ along the third direction DR3 (e.g, a height direction). The first blocking layer supply part CG1 may be disposed closer to the lens part LZ than the workpiece SBJ along the third direction DR3. The second blocking layer supply part CG2 may be disposed closer to the workpiece SBJ than the lens part LZ along the third direction DR3.

Referring to FIGS. 4 and 5, the first blocking layer supply part CG1 may include the first sub-blocking layer supply part CG1A and the second sub-blocking layer supply part CG1B spaced apart along the second direction DR2 crossing the first direction DR1.

Similarly, the second blocking layer supply part CG2 may include a third sub-blocking layer supply part CG2A and a fourth sub-blocking layer supply part CG2B spaced apart from each other along the second direction DR2.

The first sub-blocking layer supply part CG1A of the first blocking layer supply part CG1 may supply the first blocking layer CR1A, and the first blocking layer CR1A may include a plurality of first blocking particles CPT1A.

The second sub-blocking layer supply part CG1B of the first blocking layer supply part CG1 may supply the second blocking layer CR1B, and the second blocking layer CR1B may include a plurality of second blocking particles CPT1B.

The first blocking layer CR1A and the second blocking layer CR1B may be spaced apart along the second direction DR2 with the scan path LSP interposed therebetween.

The third sub-blocking layer supply part CG2A of the second blocking layer supply part CG2 may supply the third blocking layer CR2A, and the third blocking layer CR2A may supply a plurality of third blocking particles CPT2A.

The fourth sub-blocking layer supply part CG1B of the second blocking layer supply part CG2 may supply the fourth blocking layer CR2B, and the fourth blocking layer CR2B may include a plurality of fourth blocking particles CPT2B.

The third blocking layer CR2A and the fourth blocking layer CR2B may be spaced apart along the second direction DR2 with the scan path LSP interposed therebetween.

The first blocking layer CR1A and the third blocking layer CR2A may overlap each other along the third direction DR3, and the second blocking layer DR1B and the fourth blocking layer CR2B may overlap each other along the third direction DR3.

The first sub-blocking layer supply part CG1A, the second sub-blocking layer supply part CG1B, the third sub-blocking layer supply part CG2A, and the fourth sub-blocking layer supply part CG2B may be or include air knives or air nozzles, but the embodiment is not limited thereto.

The first blocking layer CR1A, the second blocking layer CR1B, the third blocking layer CR2A, and the fourth blocking layer CR2B may be or include air curtains, and a plurality of first blocking particles CPT1A, a plurality of second blocking particles CPT1B, a plurality of third blocking particles CPT2A, and a plurality of fourth blocking particles CPT2B may be or include carbon dioxide particles.

The laser processing apparatus 112 according to one or more embodiments of the present disclosure may include the first blocking layer supply part CG1 disposed between the lens part LZ and the workpiece SBJ along the third direction DR3 (e.g., a height direction), and may provide the first blocking layer CR1A and the second blocking layer CR1B, each including a plurality of first blocking particles CPT1A and a plurality of second blocking particles CPT1B, and the second blocking layer supply part CG2 that provides the third blocking layer CR2A and the fourth blocking layer CR2B, each including a plurality of third blocking particles CPT2A and a plurality of fourth blocking particles CPT2B.

In some embodiments, the second blocking layer supply part CG2 is disposed adjacent to the workpiece SBJ to reduce or prevent the spatter PT generated from the workpiece SBJ from spreading not only in the direction toward the lens part LZ but also to the surrounding process region. In some embodiments, the first blocking layer supply part CG1 is disposed adjacent to the lens part LZ to additionally reduce or prevent the spatter PT that cannot be blocked by the second blocking layer supply part CG2 from reaching the lens part LZ. In some embodiments, by reducing or preventing the spatter PT from reaching the lens part LZ through the second blocking layer supply part CG2 and the first blocking layer supply part CG1, the spatter PT may be hindered or prevented from reaching the lens part LZ even when the amount of spatter PT is high.

The first blocking layer CR1A, the second blocking layer CR1B, the third blocking layer CR2A and the fourth blocking layer CR2B supplied from the blocking layer supply parts CG1 and CG2 may reduce or prevent (e.g., as a primary measure) the spatter PT from reaching the lens part LZ with air curtains, and a plurality of first blocking particles CPT1A, a plurality of second blocking particles CPT1B, a plurality of third blocking particles CPT2A and a plurality of fourth blocking particles CPT2B may reduce or prevent (e.g., as a secondary measure) the spatter PT from reaching the lens part LZ by hitting (e.g., directly hitting) the spatter PT.

In some embodiments, the first blocking layer supply part CG1 may include the first blocking layer CR1A and the second blocking layer CR1B spaced apart along the second direction DR2 with the scan path LSP parallel to the first direction DR1 interposed therebetween, and the first blocking layer CR1A and the second blocking layer CR1B may be spaced apart along the second direction DR2 with the scan path LSP interposed therebetween. Similarly, the second blocking layer supply part CG2 may include the third blocking layer CR2A and the fourth blocking layer CR2B spaced apart along the second direction DR2 with the scan path LSP parallel to the first direction DR1 interposed therebetween, and the third blocking layer CR2A and the fourth blocking layer CR2B may be spaced apart along the second direction DR2 with the scan path LSP interposed therebetween.

In one embodiment, the first blocking layer CR1A and the second blocking layer CR1B are spaced apart along the second direction DR2 with the scan path LSP interposed therebetween, and the third blocking layer CR2A and the fourth blocking layer CR2B are spaced apart along the second direction DR2 with the scan path LSP interposed therebetween. In some embodiments, the first blocking layer CR1A, the second blocking layer CR1B, the third blocking layer CR2A, the fourth blocking layer CR2B, a plurality of first blocking particles CPT1A, a plurality of second blocking particles CPT1B, a plurality of third blocking particles CPT2A, and a plurality of fourth blocking particles CPT2B may not be disposed on the scan path LSP to which the laser LS is supplied. In one embodiment, contamination of the process environment and the lens part LZ by the spatter PT may be hindered or prevented without interfering with the path of the laser LS or reducing the energy intensity of the laser LS.

Many features of the laser processing apparatuses according to the embodiments of FIGS. 1-2 may be applicable to the laser processing apparatus according to the embodiment of FIGS. 3-5.

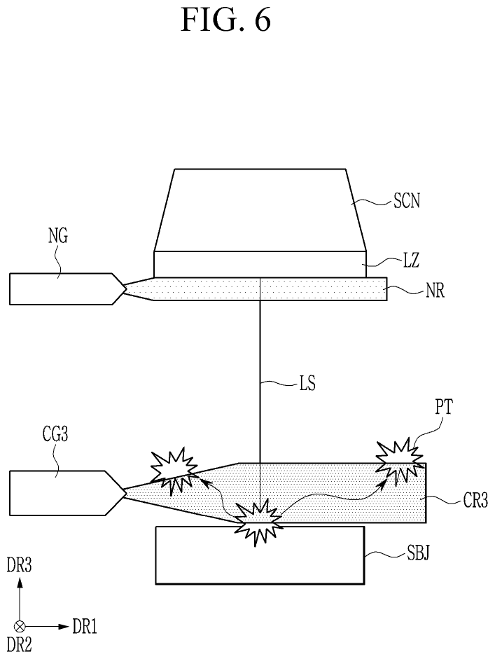

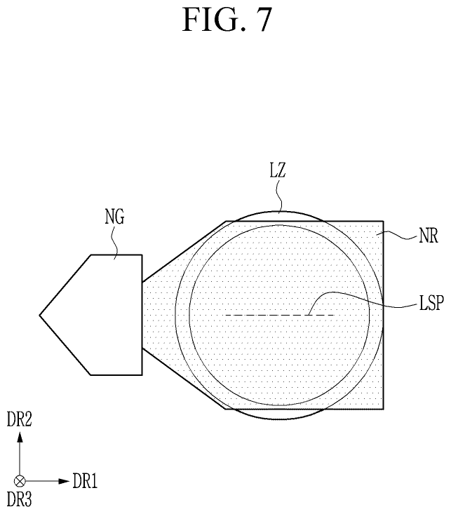

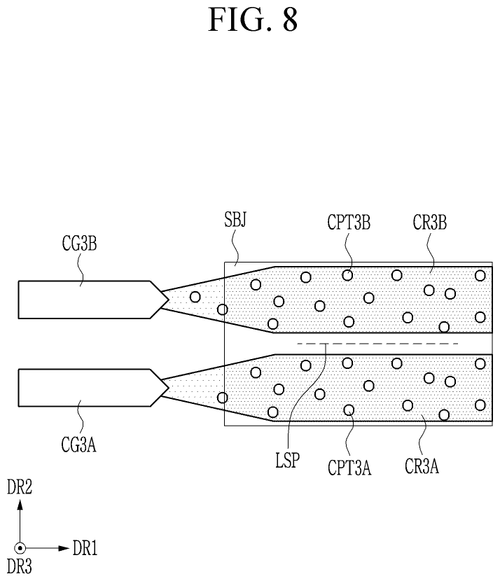

FIGS. 6 to 8 depict a laser processing apparatus 113 according to one embodiment of the present disclosure. FIG. 6 is a side view of a laser processing apparatus according to one embodiment, FIG. 7 is a plan view of a portion of the laser processing apparatus of FIG. 6, and FIG. 8 is a plan view of a portion of the laser processing apparatus of FIG. 6.

Referring to FIGS. 6 to 8, the laser processing apparatus 113 according one embodiment is similar to the laser processing apparatuses 111 and 112 according to the embodiments of FIGS. 1-5. Detailed descriptions of the same components are omitted.

Referring to FIG. 6, the laser processing apparatus 113 according to one embodiment may include the laser supply part SCN that supplies the laser LS to the processing target workpiece SBJ, the lens part LZ for focusing the laser supplied from the laser supply part SCN to the processing target workpiece SBJ, the blocking layer supply part CG3 for supplying the blocking layer CR3, and a blocking film supply part (also referred to as a film generator) NG for supplying a blocking film NR.

The laser processing apparatus 113 according to one embodiment may include the blocking film supply part NG that supplies the blocking film NR.

The blocking layer supply part CG3 and the blocking film supply part NG may be disposed between the lens part LZ and the workpiece SBJ along the third direction DR3 (e.g., a height direction), the blocking film supply part NG may be disposed closer to the lens part LZ than the workpiece SBJ along the third direction DR3, and the blocking layer supply part CG3 may be disposed closer to the workpiece SBJ than the lens part LZ along the third direction DR3.

Referring to FIGS. 7 and 8, the blocking film supply part NG may supply the blocking film NR to a region that may correspond to all regions occupied by the lens part LZ along the plane formed by crossing the first direction DR1 and the second direction DR2.

The blocking film NR may be a gas film containing an inert gas. The inert gas of the blocking film NR may include, for example, nitrogen, but the embodiment is not limited thereto.

The blocking layer supply part CG3 may include a fifth sub-blocking layer supply part CG3A and a sixth sub-blocking layer supply part CG3B spaced apart along the second direction DR2 crossing the first direction DR1.

The fifth sub-blocking layer supply part CG3A of the blocking layer supply part CG3 may supply a fifth blocking layer CR3A, and the fifth blocking layer CR3A may include a plurality of fifth blocking particles CPT3A.

The sixth sub-blocking layer supply part CG3B of the blocking layer supply part CG3 may supply a sixth blocking layer CR3B, and the sixth blocking layer CR3B may include a plurality of sixth blocking particles CPT3B.

The fifth blocking layer CR3A and the sixth blocking layer CR3B may be spaced apart along the second direction DR2 with the scan path LSP interposed therebetween.

The fifth sub-blocking layer supply part CG3A and the sixth sub-blocking layer supply part CG3B may be or include air knives or air nozzles, but the embodiment is not limited thereto.

The fifth blocking layer CR3A and the sixth blocking layer CR3B may be or include air curtains, and a plurality of fifth blocking particles CPT3A and a plurality of sixth blocking particles CPT3B may be or include carbon dioxide particles.

The laser processing apparatus 113 according to the embodiments may include the blocking layer supply part CG3 disposed between the lens part LZ and the workpiece SBJ along the third direction DR3 (e.g., a height direction), and providing the fifth blocking layer CR3A and the sixth blocking layer CR3B, each including a plurality of fifth blocking particles CPT3A and a plurality of sixth blocking particles CPT3B, and the blocking film supply part NG that provides the blocking film NR containing the inert gas.

In some embodiments, the blocking layer supply part CG3 is disposed adjacent to the workpiece SBJ to reduce or prevent the spatter PT generated from the workpiece SBJ from spreading not only in the direction toward the lens part LZ but also to the surrounding process region. in some embodiments, the blocking layer supply part NG is disposed adjacent to the lens part LZ to additionally reduce or prevent the spatter PT that is not blocked by the blocking layer supply part CG3 from reaching the lens part LZ. Therefore, by reducing or preventing the spatter PT from reaching the lens part LZ through the blocking layer supply part CG3 and the blocking film supply part NG, spatter PT may be prevented or hindered from reaching the lens part LZ even when the amount of spatter PT is high.

The fifth blocking layer CR3A and the sixth blocking layer CR3B supplied from the blocking layer supply part CG3 may reduce or prevent (e.g., as a primary measure) the spatter PT from reaching the lens part LZ with air curtains, and a plurality of fifth blocking particles CPT3A and a plurality of sixth blocking particles CPT3B may reduce or prevent (e.g., as a secondary measure) the spatter PT from reaching the lens part LZ by hitting (e.g., directly hitting) the spatter PT.

In some embodiments, the blocking layer supply part CG3 may include the fifth blocking layer CR3A and the sixth blocking layer CR3B spaced apart along the second direction DR2 with the scan path LSP parallel to the first direction DR1 interposed therebetween, and the fifth blocking layer CR3A and the sixth blocking layer CR3B may be spaced apart along the second direction DR2 with the scan path LSP interposed therebetween.

In one embodiment, the fifth blocking layer CR3A and the sixth blocking layer CR3B are spaced apart along the second direction DR2 with the scan path LSP interposed therebetween. In one embodiment, the fifth blocking layer CR3A, the sixth blocking layer CR3B, a plurality of fifth blocking particles CPT3A and a plurality of sixth blocking particles CPT3B may not be disposed on the scan path LSP to which the laser LS is supplied. In one embodiment, contamination of the process environment and the lens part LZ by the spatter PT may be hindered or prevented without interfering with the path of the laser LS or reducing the energy intensity of the laser LS.

Many features of the laser processing apparatuses according to the embodiments of FIGS. 1-5 may be applicable to the laser processing apparatus according to the embodiment of FIGS. 6-8.

While this disclosure has been described in connection with what is presently considered to be practical embodiments, it is to be understood that the disclosure is not limited to the disclosed embodiments. On the contrary, the present disclosure is intended to cover various modifications and equivalent arrangements included within the spirit and scope of the appended claims and their equivalents.

### DESCRIPTION OF SYMBOLS

111, 112, 113: Laser processing apparatus
SCN: Laser supply part
LZ: Lens part
LS: Laser
SBJ: Workpiece
PT: Spatter
LSP: Scan path
CG1, CG2, CG3: Blocking layer supply part
CG1A, CG1B, CG2A, CG2B, CG3A, CG3B: Sub-blocking layer supply part
CR1, CR2, CR3, CR1A, CR1B, CR2A, CR2B, CR3A, CR3B: Blocking layer
CPT1A, CPT1B, CPTR2A, CPT2B, CPT3A, CPT3B: Blocking particle
NGL: Blocking film supply part
NR: Blocking film

What is claimed is:

1. A laser processing apparatus, comprising:
a laser emitter configured to provide a laser along a scan path to a workpiece;
a lens arranged below the laser emitter; and
a first layer configured to supply a first blocking layer and a second blocking layer between the lens and the workpiece along a height direction,
wherein the first layer includes a first sub-layer and a second sub-layer spaced apart from each other,
the first sub-layer is configured to supply the first blocking layer,
the second sub-layer is configured to provide the second blocking layer,
the scan path is parallel to a first direction perpendicular to the height direction, and
the first blocking layer and the second blocking layer are spaced apart along a second direction perpendicular to the height direction and intersect the first direction, with the scan path interposed therebetween.

2. The laser processing apparatus as claimed in claim 1, wherein
the first blocking layer includes a plurality of first blocking particles,
and the second blocking layer includes a plurality of second blocking particles.

3. The laser processing apparatus as claimed in claim 2, wherein
the first blocking layer and the second blocking layer include an air curtain,
and the plurality of first blocking particles and the plurality of second blocking particles include carbon dioxide particles.

4. The laser processing apparatus as claimed in claim 1, wherein
the first blocking layer and the second blocking layer include an air curtain.

5. The laser processing apparatus as claimed in claim 1, wherein
the first sub-layer and the second sub-layer are closer to the lens than the workpiece along the height direction.

6. The laser processing apparatus as claimed in claim 1, further comprising
a second layer configured to supply a third blocking layer and a fourth blocking layer between the lens and the workpiece along the height direction.

7. The laser processing apparatus as claimed in claim 6, wherein
the second layer comprises a third sub-layer and a fourth sub-layer spaced apart from each other,
the third sub-layer is configured to supply the third blocking layer, and
the fourth sub-layer is configured to supply the fourth blocking layer.

8. The laser processing apparatus as claimed in claim 7, wherein
the third blocking layer and the fourth blocking layer are spaced apart from each other along the second direction with the scan path interposed therebetween.

9. The laser processing apparatus as claimed in claim 8, wherein
the third blocking layer comprises a plurality of third blocking particles,
and the fourth blocking layer comprises a plurality of fourth blocking particles.

10. The laser processing apparatus as claimed in claim 9, wherein
the third blocking layer and the fourth blocking layer comprise an air curtain,
and the plurality of third blocking particles and the plurality of fourth blocking particles comprise carbon dioxide particles.

11. The laser processing apparatus as claimed in claim 8, wherein
along the height direction, the third blocking layer overlaps the first blocking layer, and the fourth blocking layer overlaps the second blocking layer.

12. The laser processing apparatus as claimed in claim 11, wherein
along the height direction, the first layer is closer to the lens than the workpiece,
and the second layer is closer to the workpiece than the lens.

13. The laser processing apparatus as claimed in claim 12, wherein
the third blocking layer and the fourth blocking layer comprise an air curtain.

14. The laser processing apparatus as claimed in claim 6, wherein
along the height direction, the first layer is closer to the lens than the workpiece,
and the second layer is closer to the workpiece than the lens.

15. The laser processing apparatus as claimed in claim 1, further comprising
a film generator configured to supply a blocking film between the lens and the workpiece along the height direction.

16. The laser processing apparatus as claimed in claim 15, wherein
the blocking film is a gas film containing an inert gas.

17. The laser processing apparatus as claimed in claim 16, wherein
the inert gas comprises nitrogen.

18. The laser processing apparatus as claimed in claim 6, wherein
along the height direction, the film generator is closer to the lens than the workpiece,
and the first layer is closer to the workpiece than the lens.

19. The laser processing apparatus as claimed in claim 18, wherein
the film generator is disposed based on a region occupied by the lens along a plane direction formed by the first direction and the second direction.

20. The laser processing apparatus as claimed in claim 19, wherein
the first blocking layer comprises a plurality of first blocking particles,
the second blocking layer comprises a plurality of second blocking particles,
the first blocking layer and the second blocking layer comprise an air curtain,
and a plurality of first blocking particles and a plurality of second blocking particles comprise carbon dioxide particles.
